(19) United States
(12) Patent Application Publication
(10) Pub. No.: US 2024/0068708 A1
(43) Pub. Date: Feb. 29, 2024

(54) FLOW-THROUGH HEATER

(71) Applicant: WATLOW ELECTRIC MANUFACTURING COMPANY, St. Louis, MO (US)

(72) Inventors: Julian MICHELSEN, Landshut (DE); Todd BROOKE, Columbia, MO (US); Terry COLHOUR, Fulton, MO (US)

(73) Assignee: WATLOW ELECTRIC MANUFACTURING COMPANY, St. Louis, MO (US)

(21) Appl. No.: 17/896,444

(22) Filed: Aug. 26, 2022

(51) Int. Cl. F24H 9/00; F28F 13/08; G01K 7/16; G01K 13/02; H05B 3/06

(52) U.S. Cl. CPC F24H 9/00; F28F 13/08; G01K 7/16; G01K 13/02; H05B 3/06; H05B 2203/007; H05B 2203/016; H05B 2203/037

(57) ABSTRACT

A flow-through heater assembly includes a housing and a heater. The housing includes an inlet, an outlet, and a bore extending between the inlet and the outlet. The heater is disposed within the housing and extends between the inlet and the outlet. The heater includes at least one opening proximate the inlet and at least one opening proximate the outlet. The heater defines an anfractuous path from the inlet to the outlet, and the openings in the heater are in fluid communication with the bore of the housing.

### FIELD

The present disclosure relates to flow-through heaters, and more particularly to heaters for use heating a fluid flow within such heaters.

### BACKGROUND

The statements in this section merely provide background information related to the present disclosure and may not constitute prior art.

Referring to FIG. 1, a typical flow-through heater assembly 10 includes a tubular flow body 12, an external heater 14 installed onto the outside of the tubular flow body 12, and a baffle 16 located within a flow path “F” within the tubular flow body 12. Heat is transferred from the external heater 14 through the tubular flow body 12 and into a fluid 18 flowing therein. The baffle 16 is designed to increase the turbulence of the fluid 18 and thus increase the heat transfer efficiency between an inner surface of the tubular flow body 12 and the fluid 18.

With this conventional design, the external heater 14 provides advantages in terms of electrical integration, chemical compatibility, and cleanliness of a given application, such as by way of example semiconductor processing environments (e.g., forelines and exhaust lines). However, these existing flow-through heater assemblies are difficult to maintain when, for example, the internal baffle 16 or interior of the tubular flow body 12 needs to be cleaned or serviced. Additionally, thermal transfer from the external heater 14, through the wall of the tubular flow body 12, and ultimately into the fluid 18 is relatively inefficient.

These issues related to flow-through heaters are addressed by the present disclosure.

### SUMMARY

This section provides a general summary of the disclosure and is not a comprehensive disclosure of its full scope or all of its features.

In one form of the present disclosure, a flow-through heater assembly comprises a housing having an inlet, an outlet, and a bore extending between the inlet and the outlet. A heater is disposed within the housing and extends between the inlet and the outlet, the heater comprising at least one opening proximate the inlet and at least one opening proximate the outlet, the heater further defining an anfractuous path from the inlet to the outlet. The openings in the heater are in fluid communication with the bore of the housing.

In variations of this flow-through heater assembly, which may be implemented individually or in any combination: the housing comprises two pieces; the two pieces comprise an upper body half and a lower body half, each of the upper body half and the lower body half comprising adjacent perimeter edges following the anfractuous path; each of the adjacent perimeter edges comprise a circuitous groove and the flow-through heater further comprises an upper o-ring disposed within the circuitous groove of the upper body half and a lower o-ring disposed within the circuitous groove of the lower body half; the heater is disposed against the upper o-ring and the lower o-ring; the upper body half and the lower body half are secured together with mechanical fasteners; the mechanical fasteners extend through the heater; each of the upper body half and the lower body half comprise one of the inlet and the outlet; the upper body half and the lower body half are identical in shape; the heater further comprises integral termination pads; the integral termination pads extend laterally from a mid-section of the heater and through a sidewall of the housing; the housing comprises internal grooves configured to receive the heater, the internal grooves following the anfractuous path of the heater; the anfractuous path defines a sine-wave shape; a plurality of heaters extend between the inlet and the outlet; the heater comprises a variable watt density; the heater comprises a material having a sufficient TCR such that the heater functions as a heater and a temperature sensor; at least one temperature sensor is disposed within the housing; the temperature sensor comprises a ribbon extending along a surface of the heater with a junction disposed at a predetermined location; the heater is selected from the group consisting of a polyimide heater, a layered heater, a heat trace heater, a tubular heater, a cartridge heater, and a cable heater; and the flow-through heater assembly is formed by an additive manufacturing process.

In another form of the present disclosure, a flow-through heater assembly comprises a two-piece housing comprising an inlet, an outlet, and a bore extending between the inlet and the outlet. A heater is disposed within the two-piece housing and extending between the inlet and the outlet, the heater comprising at least one opening proximate the inlet and at least one opening proximate the outlet, the heater further defining an anfractuous path from the inlet to the outlet, wherein the openings in the heater are in fluid communication with the bore of the housing.

In yet another form of the present disclosure, a flow-through heater assembly comprises a two-piece housing comprising an inlet, an outlet, and a bore extending between the inlet and the outlet, the two-piece housing defining an upper body half and a lower body half, each of the upper body half and the lower body half comprising adjacent perimeter edges having a circuitous groove. An upper o-ring is disposed within the circuitous groove of the upper body half, a lower o-ring is disposed within the circuitous groove of the lower body half, and a heater is disposed within the two-piece housing and extends between the inlet and the outlet against each of the upper o-ring and the lower o-ring. The heater comprises at least one opening proximate the inlet and at least one opening proximate the outlet, the heater further defining an anfractuous path from the inlet to the outlet. The openings in the heater are in fluid communication with the bore of the housing, and the adjacent perimeter edges of the upper body half and the lower body half follow the anfractuous path of the heater.

In still another form, a flow-through heater assembly comprises a housing having an inlet, an outlet, and a bore extending between the inlet and the outlet. A heater is disposed within the housing and extends between the inlet and the outlet, the heater comprising distal end portions disposed across each of the inlet and the outlet. The heater further defines an anfractuous path from the inlet to the outlet.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic side cross-sectional view of a prior art flow-through heater assembly;

FIG. 2 is a perspective view of a flow-through heater assembly constructed according to the teachings of the present disclosure;

FIG. 3 is an exploded view of the flow-through heater of FIG. 2;

FIG. 4 is a cross-sectional view of the flow-through heater assembly of FIG. 2;

FIG. 5A is a perspective view of a lower body half of a housing and an o-ring of the heater assembly of FIG. 2 constructed according to the present disclosure;

FIG. 5B is a perspective view of a heater and another o-ring disposed on the lower body half of FIG. 5A;

FIG. 6 is a perspective view of a flexible polyimide heater constructed according to the present disclosure;

FIG. 7 is a schematic side cross-sectional view of the flow-through heater assembly of FIG. 2 and a fluid flow according to the present disclosure; and

FIG. 8 is a side cross-sectional view of another flow-through heater assembly having a plurality of heaters according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

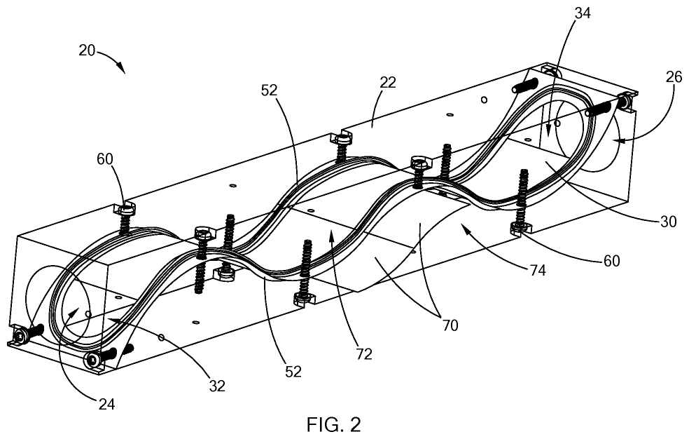

Referring to FIGS. 2-4, a flow-through heater assembly according to the present disclosure is illustrated and generally indicated by reference numeral 20. The flow-through heater assembly 20 includes a housing 22 having an inlet 24, an outlet 26, and a bore 28 extending between the inlet 24 and the outlet 26. The flow-through heater assembly further includes a heater 30 disposed within the housing 22 and extending between the inlet 24 and the outlet 26.

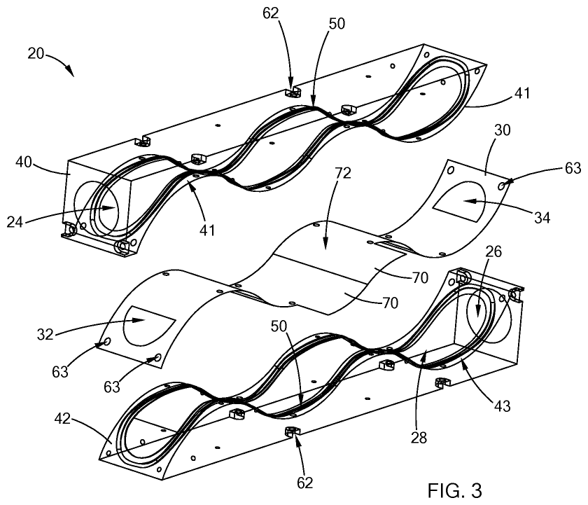

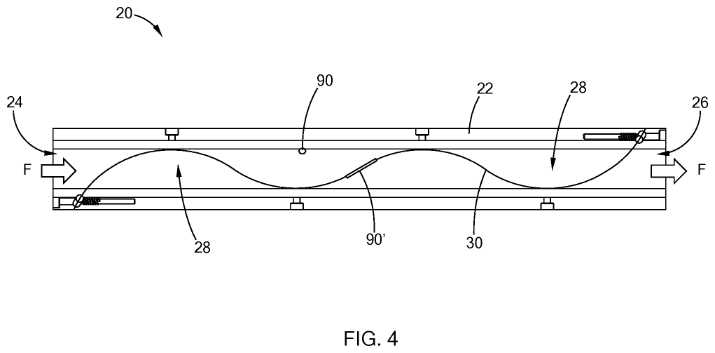

As best shown in FIG. 3, the heater 30 comprises at least one opening 32 proximate the inlet 24 and at least one opening 34 proximate the outlet 26. As described in greater detail below, the heater 30 defines an anfractuous path from the inlet 24 to the outlet 26, and the openings 32 and 34 are in fluid communication with the bore 28 of the housing 22. In operation, fluid generally flows into the inlet 24 and opening 32, through the bore 28 and along the heater 30, and out through the other opening 34 and outlet 26, as indicated by the fluid flow “F” (FIG. 4).

In one alternative form not specifically shown, such as one with a different number of sinuations along the anfractuous path, a first portion of the fluid flow F does not flow through the opening 32 and remains on the one side of the heater 30 before exiting the housing 22 via the outlet 26 while the remainder of the fluid flow F may flow through the opening 32 and remain on the opposite side of the heater 30 before flowing through another opening (i.e., similar to opening 34) proximate the outlet 26 to rejoin the first portion of the fluid flow F to exit through the outlet 26. Alternately, the ends of the heater 30 may be disposed across each of the inlet 24 and the outlet 26 and split the fluid flow F without having openings 32/24. These and other variations of the flow-through heater assembly 20 should be construed as falling within the scope of the present disclosure.

In one form as shown, the housing 22 includes two pieces, an upper body half 40 and a lower body half 42. Each of the upper body half 40 and the lower body half 42 includes an opening that forms either the inlet 24 or the outlet 26. Advantageously, in one form, the upper body half 40 and the lower body half 42 define the same geometry such that only one unique part number is used for the housing 22 assembly. It should be understood, however, that the housing 22 may be provided as a unitized component (set forth in greater detail below) or in multiple pieces that are not necessarily identical halves while remaining within the scope of the present disclosure. Additionally, while the exterior profile of the housing 22 is illustrated herein as square, other geometries such as rectangular or circular, among others and combinations thereof, are to be understood as being within the teachings of the present disclosure.

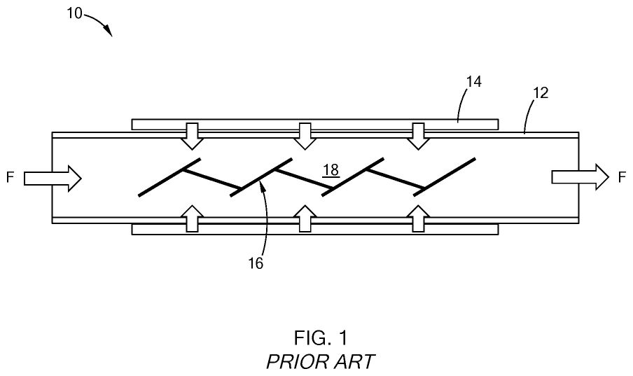

As shown, the heater 30 defines an anfractuous path from the inlet 24 to the outlet 26. As used herein, the term “anfractuous path” should be construed to mean a curved (but not straight) path that twists and/or turns in multiple directions, such as by way of example an S-shaped or sine-wave shaped path, along which fluid is forced to flow from the inlet 24 to the outlet 26. Thus, with its anfractuous path, the heater 30 is configured to function as a baffle, taking on multiple directions in 3D space. This innovative anfractuous path of the heater 30 increases turbulence of the fluid flow F through the flow-through heater assembly 20, thereby improving heat transfer from the heater 38 to the fluid F. Thus, a desired fluid temperature of the flowing fluid F is reached more readily with less power provided to the heater 38 than an external heater 14 disposed outside the tubular flow body 12 (FIG. 1). It should also be understood that the anfractuous path may be over a portion of the length of the heater 30 and does not have to necessarily extend all the way from the inlet to the outlet while remaining within the scope of the present disclosure. Further, the anfractuous path may be over a portion of the length of the heater 30, or be arranged in zones along the length of the heater 30, while remaining within the scope of the teachings herein.

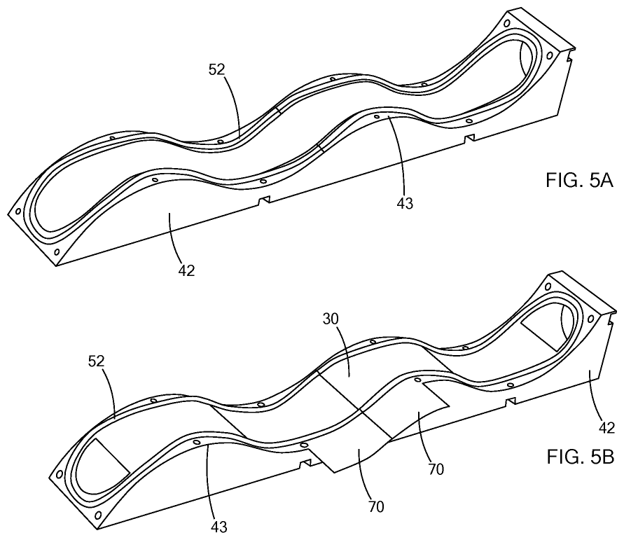

Referring also to FIGS. 5A-5B, the upper and lower body halves 40, 42 are similarly shaped with an anfractuous interior profile as shown to accommodate assembly with the heater 30. Each of the upper body half 40 and the lower body half 42 include adjacent perimeter surfaces 41/43 following the anfractuous path. More specifically, in this form, both the upper body half 40 and the lower body half 42 include the adjacent perimeter surfaces 41/43 having a circuitous groove 50 (FIG. 3) extending around an interior perimeter as shown. The circuitous grooves 50 are arranged to receive a seal, such as an o-ring 52, to seal an interface between the upper and lower body halves 40/42 and the heater 30. Thus, the heater 30 is disposed against the upper and lower o-rings 52 in this form of the present disclosure.

In one form, the upper body half 40 is secured to the lower body half 42 by mechanical fasteners 60 (FIG. 2), such by way of example, screws, bolts, and/or dowels, among others, that extend through holes 62 in the upper and lower body halves 40, 42. Tightening the upper and lower body halves 40, 42 together with the mechanical fasteners 60 thus compresses the o-rings 52 to seal the interface between the heater 30 and the upper and lower body halves 40/42 from fluid flow within the housing 22. It should be understood, however, that the upper and lower body halves 40/42 may be secured to each other using other means, such as by way of example, adhesives, welding or mechanical latches, among others, and may include other features such as hinges for ease of maintenance while remaining within the scope of the present disclosure. Further, in this form, the mechanical fasteners 60 also extend through the heater 30 as shown. Accordingly, the heater 30 includes a plurality of peripheral openings 63 configured to receive the mechanical fasteners 60. It should be understood, however, that these peripheral openings 63 are optional and the heater 30 may be secured between the upper and lower body halves 40/42 by other means.

As further shown, the heater 30 includes integral termination pads 70 extending laterally from a mid-section 72 of the heater 38. The termination pads 70 are configured to receive power leads (shown below) to supply power to the heater 30. In this form, the termination pads 70 extend through a sidewall 74 of the housing 22 where the upper body half 40 meets the lower body half 42. The termination pads 70 in this form are integral with the mid-section 72 of the heater 38. However, it should be understood that the termination pads 70 may be a separate component rather than integral, and/or may exit the housing 22 at a different location besides the mid-section 72 of the heater 30 while remaining within the scope of the present disclosure.

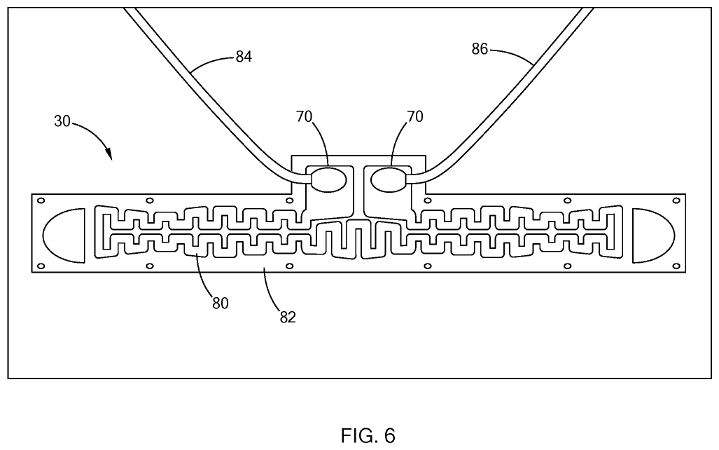

Referring to FIG. 6, one form of the heater 30 and integral termination pads 70 are illustrated in greater detail. In this form, the heater 30 comprises a resistive heating element 80 encapsulated in a polyimide material 82. Power leads 84 and 86 are connected to the termination pads 70, for example by way of soldering. The entire heater 30 in this form is thus flexible, thus allowing it to conform to the shapes of the upper and lower body halves 40/42 during assembly. However, the heater 30 may instead be preformed into the anfractuous shape while remaining within the scope of the present disclosure.

The heater 30 may be any of a variety of heaters to provide the requisite power to reach a specified fluid temperature. For example, the heater 30 may be a polyimide heater as illustrated and described herein, a layered heater (thick film, thin film, thermal spray, sol-gel), a heat trace, a tubular heater, a cartridge heater, or a cable heater, among others. Further, the heater 30 may comprise a plurality of individual heaters arranged in zones (not shown) rather than a single heating element as shown. An example of such a heater system with a plurality of individual heaters is illustrated and described in U.S. Pat. No. 10,247,445, and its related family of patents and applications, which are commonly owned with the present application and are incorporated herein by reference in their entirety.

In another form, the heater 30 has a variable watt density. In this context, a “watt density” is an amount of wattage of power output by the heater 30 per unit area, and a “variable watt density” means that the watt density of at least one portion of the heater 30 differs from the watt density of another portion of the heater 30. Such a variable watt density is illustrated and described in U.S. Pat. No. 9,113,501 and its related family of patents and applications, which are commonly owned with the present application and are incorporated herein by reference in their entirety. By way of example, in one form, the watt density of a center portion of the heater 30 is greater than the watt density of an edge portion of the heater 30, increasing heat generated by the center portion relative to the edge portion. The variable watt density of the heater 30 can also be configured to cause thermal gradients in the fluid flow F between the portions of the heater 30 with higher watt densities and lower watt densities, further increasing turbulence of the fluid flow F and thus moving colder fluid toward the portions of the heater 30 with higher watt densities.

In another form, the heater 30 is made of a material having a thermal coefficient of resistance (TCR) sufficient such that the heater 38 functions to heat the fluid and as a temperature sensor to detect the fluid temperature. By measuring the change in electrical resistance of the heater 38, the temperature of the fluid is determined based on the TCR. Thus, sensing the change in electrical resistance of the heater 38 acts as a correlative measure of the fluid temperature, and the heater 38 thus serves a dual function and also acts as a temperature sensor.

Alternatively, or additionally, the flow-through heater assembly 20 includes a temperature sensor 90 (FIG. 4) disposed within the housing 22. In one form, the temperature sensor 90 is a ribbon 90′ extending along a surface of the heater 30 with a junction disposed at a predetermined location. The temperature sensor 90/90′ detects the fluid temperature at the predetermined location, providing data to determine whether the fluid is heated to a specified temperature prior to exiting the outlet 26. Based on the data, a power controller (not shown) adjusts power to the heater 30 to attain the desired temperature. The temperature sensor 90/90′ is a suitable type, such as a thermocouple, a thermistor, or a material with a specified TCR as described above, among others.

In one form, the flow-through heater assembly 20 is formed by an additive manufacturing process, such as by way of example, laser sintering, binder jetting, or sheet lamination. In such processes, layers of material are deposited to form each of the halves of the housing (40/42), as well as the heater 30, including the anfractuous profiles. In one form, metallic powder is deposited onto a substrate and a laser fuses the powder into a solid metal layer. Then, additional metallic powder is deposited onto the solidified layer and fused by the laser into another layer. The fused layers are successively built to form some or all of the components of the flow-through heater assembly 20, thereby eliminating the need for the mechanical fasteners 60 and the seals 52 as illustrated and described above. By using an additive manufacturing process, complex geometries, such as the anfractuous path, can be more easily achieved to improve heating of the fluid in the flow-through heater assembly 20.

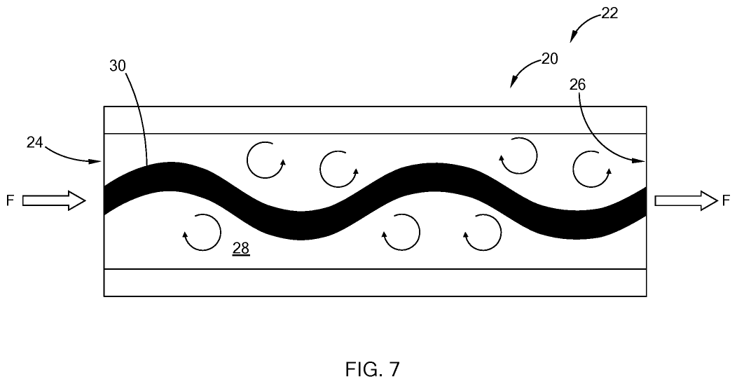

Referring now to FIG. 7, the flow-through heater assembly 20 increases turbulence in fluid F flowing through the bore 28, thus improving heat transfer from the heater 30 to the fluid F. The fluid flows into the inlet 24 of the flow-through heater assembly 20 and contacts the heater 30. Because the path of the heater 30 is anfractuous, the heater 30 more efficiently disrupts the flow of the fluid. The increased turbulence causes more fluid to deflect against the interior surfaces of the housing 22 and to contact the heater 30 directly, transferring heat from the heater 30 to the fluid. Then, the more evenly and efficiently heated fluid exits the flow-through heater assembly 20 through the outlet 26.

The shape of the heater 30, and more specifically its anfractuous path, is predetermined to attain a specified thermal time constant to heat the fluid flowing through the flow-through heater assembly 20. In this context, a “thermal time constant” (or “time constant” herein) is a time for a temperature gradient between a current temperature of the fluid and the temperature of the heater to reach a specified percentage (usually 63.2%) of an initial temperature gradient. The “initial temperature gradient” is defined by a fluid temperature prior to the inlet and the temperature of the heater. A heater with a lower thermal time constant means that the fluid reaches a target temperature faster than a heater with a higher thermal constant. Reducing the thermal time constant of the flow-through heater assembly 20 results in heating the fluid more efficiently than a conventional heater, and by replacing a traditional baffle (which acts as a heat sink) with the heater 30 having the anfractuous path, the thermal time constant is reduced.

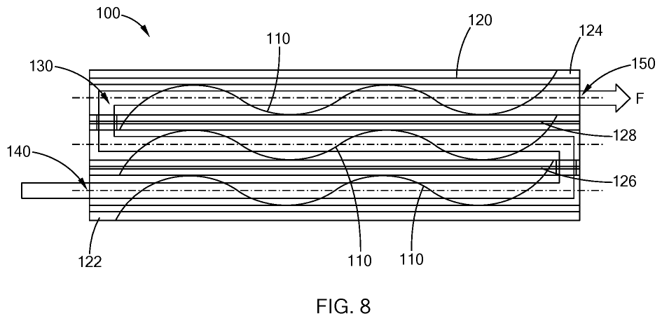

Referring now to FIG. 8, another form of a “stacked” flow-through heater assembly is illustrated and generally indicated by reference numeral 100. The flow-through heater 100 includes a plurality of individual heaters 110 disposed in a multi-chambered housing 120. The housing 120 includes a lower piece 122, an upper piece 124, and two (2) intermediate pieces 126 and 128. A continuous fluid conduit 130 is formed across all pieces in the housing 120 as shown, and the fluid F flows from the lower piece 122 through the intermediate pieces 126 and 128 across and then through the upper piece 124.

The lower piece 122 includes an inlet 140, and the upper piece 124 includes an outlet 150, as described above. Each intermediate piece 126 and 128 includes an opening through which fluid flows from the lower piece 64 to the upper piece 68 or between two adjacent intermediate pieces 66. The heaters 110 may be connected in electrical series, or each heater may have its own termination pads and power supply as described above. With each heater having its own termination pads, a zoned heater assembly can be provided to provide different amounts of power for each layer of the stack. By stacking the heaters 110 and in the anfractuous path, the flow-through heater assembly 100 provides a longer fluid flow path without increasing a length of the housing 120. It should be understood that two adjacent intermediate pieces 66 is merely exemplary, and thus one or more than two adjacent intermediate pieces 66 may be employed while remaining within the scope of the present disclosure. These and other variations of the innovative flow-through heater assembly should be construed as falling within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A flow-through heater assembly comprising:
a housing comprising an inlet, an outlet, and a bore extending between the inlet and the outlet; and
a heater disposed within the housing and extending between the inlet and the outlet, the heater comprising at least one opening proximate the inlet and at least one opening proximate the outlet, the heater further defining an anfractuous path from the inlet to the outlet,
wherein the openings in the heater are in fluid communication with the bore of the housing.

2. The flow-through heater assembly according to claim 1, wherein the housing comprises two pieces.

3. The flow-through heater assembly according to claim 2, wherein the two pieces comprise an upper body half and a lower body half, each of the upper body half and the lower body half comprising adjacent perimeter edges following the anfractuous path.

4. The flow-through heater assembly according to claim 3, wherein each of the adjacent perimeter edges comprise a circuitous groove and the flow-through heater further comprises an upper o-ring disposed within the circuitous groove of the upper body half and a lower o-ring disposed within the circuitous groove of the lower body half.

5. The flow-through heater assembly according to claim 4, wherein the heater is disposed against the upper o-ring and the lower o-ring.

6. The flow-through heater assembly according to claim 3, wherein the upper body half and the lower body half are secured together with mechanical fasteners.

7. The flow-through heater assembly according to claim 6, wherein the mechanical fasteners extend through the heater.

8. The flow-through heater assembly according to claim 3, wherein each of the upper body half and the lower body half comprise one of the inlet and the outlet.

9. The flow-through heater assembly according to claim 8, wherein the upper body half and the lower body half are identical in shape.

10. The flow-through heater assembly according to claim 1, wherein the heater further comprises integral termination pads.

11. The flow-through heater assembly according to claim 10, wherein the integral termination pads extend laterally from a mid-section of the heater and through a sidewall of the housing.

12. The flow-through heater assembly according to claim 1, wherein the housing comprises internal grooves configured to receive the heater, the internal grooves following the anfractuous path of the heater.

13. The flow-through heater assembly according to claim 1, wherein the anfractuous path defines a sine-wave shape.

14. The flow-through heater assembly according to claim 1, further comprising a plurality of heaters extending between the inlet and the outlet.

15. The flow-through heater assembly according to claim 1, wherein the heater comprises a variable watt density.

16. The flow-through heater assembly according to claim 1, wherein the heater comprises a material having a sufficient TCR such that the heater functions as a heater and a temperature sensor.

17. The flow-through heater assembly according to claim 1, further comprising at least one temperature sensor disposed within the housing.

18. The flow-through heater assembly according to claim 17, wherein the temperature sensor comprises a ribbon extending along a surface of the heater with a junction disposed at a predetermined location.

19. The flow-through heater assembly according to claim 1, wherein the heater is selected from the group consisting of a polyimide heater, a layered heater, a heat trace heater, a tubular heater, a cartridge heater, and a cable heater.

20. The flow-through heater assembly according to claim 1, wherein the flow-through heater assembly is formed by an additive manufacturing process.

21. A flow-through heater assembly comprising:
a two-piece housing comprising an inlet, an outlet, and a bore extending between the inlet and the outlet; and
a heater disposed within the two-piece housing and extending between the inlet and the outlet, the heater comprising at least one opening proximate the inlet and at least one opening proximate the outlet, the heater further defining an anfractuous path from the inlet to the outlet,
wherein the openings in the heater are in fluid communication with the bore of the housing.

22. A flow-through heater assembly comprising:
a two-piece housing comprising an inlet, an outlet, and a bore extending between the inlet and the outlet, the two-piece housing defining an upper body half and a lower body half, each of the upper body half and the lower body half comprising adjacent perimeter edges having a circuitous groove;
an upper o-ring disposed within the circuitous groove of the upper body half;
a lower o-ring disposed within the circuitous groove of the lower body half; and
a heater disposed within the two-piece housing and extending between the inlet and the outlet against each of the upper o-ring and the lower o-ring, the heater comprising at least one opening proximate the inlet and at least one opening proximate the outlet, the heater further defining an anfractuous path from the inlet to the outlet,
wherein the openings in the heater are in fluid communication with the bore of the housing and the adjacent perimeter edges of the upper body half and the lower body half follow the anfractuous path of the heater.

23. A flow-through heater assembly comprising:
a housing comprising an inlet, an outlet, and a bore extending between the inlet and the outlet; and
a heater disposed within the housing and extending between the inlet and the outlet, the heater comprising distal end portions disposed across each of the inlet and the outlet, the heater further defining an anfractuous path from the inlet to the outlet.
